(19) United States
(12) Patent Application Publication
(10) Pub. No.: US 2025/0276294 A1
(43) Pub. Date: Sep. 4, 2025

(54) QUENCH DEVICE AND MIXING METHOD FOR IMPROVING MIXING EFFECT OF QUENCH GAS AND SYNTHESIS GAS

(71) Applicant: HUANENG (TIANJIN) GAS POWER CO., LTD., Tianjin (CN)

(72) Inventors: Xiangping WANG, Tianjin (CN); Ke ZHANG, Tianjin (CN); Pihuan CUI, Tianjin (CN); Chao WANG, Tianjin (CN); Huiji SONG, Tianjin (CN); Xiaomeng KANG, Tianjin (CN); Yuntao AI, Tianjin (CN); Lihui ZHOU, Tianjin (CN); Ziyu GONG, Tianjin (CN); Fanming DENG, Tianjin (CN); Zeyu TONG, Tianjin (CN); Zhe WANG, Tianjin (CN)

(21) Appl. No.: 19/087,411

(22) Filed: Mar. 21, 2025

Related U.S. Application Data
(63) Continuation of application No. PCT/CN2025/076620, filed on Feb. 10, 2025.

(30) Foreign Application Priority Data
Mar. 4, 2024 (CN) 202410242288.7

(51) Int. Cl. B01F 23/10; B01F 27/053; B01F 27/112; B01F 35/32; C10J 3/48

(52) U.S. Cl. CPC B01F 23/14; B01F 27/053; B01F 27/112; B01F 35/32015; C10J 3/487

(57) ABSTRACT

The disclosure relates to the technical field of gas mixing, and particularly relates to a quench device and a mixing method for improving mixing effect of quench gas and synthesis gas. The quench device includes a plurality of quench gas ports installed on a dry pulverized coal gasifier body and a guide wheel installed in the quench gas ports. A cross section of the dry pulverized coal gasifier body is a first imaginary circle, and the plurality of quench air ports are arranged along a circumference of the first imaginary circle. A number of the quench air ports is positive even number, and every two quench air ports form a rotary hedging group. Two quench air ports of a same rotating hedging group are arranged on a circumference of a same first imaginary circle and symmetrically arranged around a center of the first imaginary circle.

### CROSS-REFERENCE TO RELATED APPLICATIONS

This application is a continuation of PCT/CN2025/076620, filed on Feb. 10, 2025 and claims priority of Chinese Patent Application No. 202410242288.7, filed on Mar. 4, 2024, the entire contents of which are incorporated herein by reference.

### TECHNICAL FIELD

The disclosure relates to the technical field of gas mixing, and particularly relates to a quench device and a mixing method for improving mixing effect of quench gas and synthesis gas.

### BACKGROUND

Coal gasification technology is one of the leading technologies in modern coal chemical industry. Dry pulverized coal gasification has the characteristics of high gasification parameters, large gasification capacity, high performance index, good environmental protection performance and wide adaptability of coal types, and it has been applied to coal chemical projects and integrated gasification combined cycle (IGCC) power generation projects.

In the prior art, there are problems of leakage and uneven mixing of quench gas and synthesis gas in the collision flow field of dry pulverized coal gasifier, which leads to insufficient heat exchange between synthesis gas and quench gas. At the same time, the residence time of high temperature coal ash and incompletely reacted pulverized coal particles in the furnace is short, and they rotate and flow with the synthesis gas flow, causing the coal ash and pulverized coal particles to adhere to the relevant channels and causing the blockage of the relevant channels. It causes ash deposition in gasifier and poor heat exchange of waste heat boiler, which affects the safe and stable operation of gasifier, and at the same time causes certain carbon loss and reduces the carbon conversion rate of gasifier. The shutdown of gasifier caused by ash deposition is the main factor of abnormal shutdown of gasifier. Taking 2000 t dry pulverized coal gasifier as an example, the direct economic loss of each shut down is more than 2 million yuan, which is huge.

### SUMMARY

The disclosure aims to provide a quench device and a mixing method for improving mixing effect of quench gas and synthesis gas, so as to solve the problems of leakage and uneven mixing of quench gas and synthesis gas in the collision flow field of dry pulverized coal gasifier in the prior art.

In order to achieve the above purpose, the disclosure adopts the following technical scheme:
In a first aspect of the disclosure, a quench device for improving mixing effect of quench gas and synthesis gas is provided, which includes a plurality of quench gas ports installed on a dry pulverized coal gasifier body and a guide wheel installed in the quench gas ports;
where a cross section of the dry pulverized coal gasifier body is a first imaginary circle, and the plurality of quench air ports are arranged along a circumference of the first imaginary circle; a number of the quench air ports is positive even number, and every two quench air ports form a rotary hedging group; two quench air ports of a same rotating hedging group are arranged on a circumference of a same first imaginary circle and symmetrically arranged around a center of the first imaginary circle;
the guide wheel is used for guiding quench air; where at least one rotary hedging group is provided with the guide wheel.

Further, the guide wheel includes a guide blade sleeve, guide blades and a blade shaft;
the guide blade sleeve is used for being installed in the quench air ports and being connected with the quench air ports;
the guide blades and the blade shaft are arranged in the guide blade sleeve, and the guide blades is fixedly connected with the blade shaft and the guide blade sleeve.

Further, a first end of each of the guide blades is connected with the blade shaft, and a second end of each of the guide blades is connected with an inner wall of the guide blade sleeve;
each of the guide blades is twisted from the first end to the second end.

Further, an inlet guide cone is arranged at one end, located on an air inlet side of the guide wheel, of the blade shaft.

Further, the quench air ports are arranged towards the center of the first imaginary circle; or, an extension line facing each of the quench air ports is tangent to a second imaginary circle, the second imaginary circle is a concentric circle of the first imaginary circle, and a diameter of the second imaginary circle is smaller than a diameter of the first imaginary circle.

Further, the dry pulverized coal gasifier body is provided with a cross section, and at least one rotating hedging group is arranged on a circumference of a first imaginary circle corresponding to the cross section.

Further, the dry pulverized coal gasifier body is sequentially provided with at least two cross sections from top to bottom; at least one rotary hedging group is arranged on a circumference of a first imaginary circle corresponding to each of the cross sections.

Further, when at least two rotating hedging groups are arranged on a circumference of a same first imaginary circle, the quench gas ports are uniformly arranged along a circumference of the first imaginary circle.

Further, both the guide blades and the blade shaft are made of 8825 alloy material.

In a second aspect of the disclosure, a mixing method for synthesis gas and quench gas, the method is realized based on the quench device for improving mixing effect of quench gas and synthesis gas, the method includes:
enabling quench air in the quench air ports to rotate with the blade shaft as a rotating shaft under an action of the guide blades, and enabling a flow rate of the quench air to increase, after the quench air is ejected from the quench air ports, performing collision and mixing with a second-stage synthesis gas in the dry pulverized coal gasifier body.

Compared with the prior art, the disclosure has the following beneficial effects.

In the quench device provided by this scheme, the guide wheel is installed in the quench air ports, the guide wheel can guide the quench air, increase the flow rate of the quench air, and improve the mixing effect of the quench air and synthesis gas.

In this scheme, the guide wheel includes a guide blade sleeve, guide blades and a blade shaft. The guide blade sleeve is used to be installed in the quench air port and be connected with the quench air port. The guide blades and blade shaft are arranged in the guide blade sleeve, and the guide blade is fixedly connected with the blade shaft and the guide blade sleeve, and the guide blade is twisted from the first end to the second end. Under the action of the guide blade, the quench air rotates with the blade shaft as the rotating shaft, and the flow rate of the quench air can be increased. After the quench air is ejected from the quench air port, collision and mixing are performed with a second-stage synthesis gas in the dry pulverized coal gasifier body, the mixing effect is further improved.

In this scheme, the quench air port is arranged towards the center of the first imaginary circle; or, the extension line facing the quench gas port is tangent to the second imaginary circle, and after the quench gas is ejected, it can collide in the direction opposite to the rotation of the synthesis gas, and the mixing effect can also be improved.

### BRIEF DESCRIPTION OF THE DRAWINGS

The accompanying drawings, which constitute a part of this disclosure, are used to provide a further understanding of the disclosure, and the illustrative embodiments of the disclosure and their descriptions are used to explain the disclosure, and do not constitute undue limitations on the disclosure. In the attached drawings:

FIG. 1 is a schematic structural diagram of a dry pulverized coal gasifier according to an embodiment of the disclosure;

FIG. 2 is a schematic diagram of the arrangement of quench air ports according to an embodiment of the disclosure; where, taking the arrangement of a rotating hedging group as an example, two quench air ports are relatively arranged on the same circumference;

FIG. 3 is a structural sectional diagram of the guide wheel according to an embodiment of the disclosure;

FIG. 4 is a structural diagram of the guide wheel according to an embodiment of the disclosure;

FIG. 5 is a schematic diagram of the orientation arrangement of the quench air ports according to an embodiment of the disclosure; where, 8 quench air ports are arranged; and

FIG. 6 is a schematic view of the orientation of a first pulverized coal burner according to an embodiment of the disclosure.

List of reference characters: 1 quench gas port; 2 guide wheel; 21 guide blade sleeve; 22 guide blade; 23 blade shaft; 3 dry pulverized coal gasifier body; 4 inlet guide cone; 5 first imaginary circle; 6 second imaginary circle; 7 first-stage reaction chamber; 8 second-stage reaction chamber; 9 first pulverized coal burner; 10 slag discharge port; 11 second-stage pulverized coal burner; 12 synthesis gas outlet reverse chamber; 13 heat exchanger channel; 14 heat exchanger; and 15 air inlet pipeline.

### DETAILED DESCRIPTION OF THE EMBODIMENTS

The disclosure will be described in detail with reference to the attached drawings and embodiments. It should be noted that the embodiments in this disclosure and the features in the embodiments can be combined with each other without conflict.

The following detailed description is exemplary and is intended to provide a further detailed description of the disclosure. Unless otherwise specified, all technical terms used in the disclosure have the same meaning as commonly understood by ordinary skilled in the field to which this disclosure belongs. The terminology used in the disclosure is only for describing specific embodiments, and is not intended to limit exemplary embodiments according to the disclosure.

In the description of the disclosure, it should be understood that the azimuth or positional relationship indicated by the terms “center”, “longitudinal”, “transverse”, “upper”, “lower”, “front”, “rear”, “left”, “right”, “vertical”, “horizontal”, “top”, “bottom”, “inner” and “outer” is based on the azimuth or positional relationship shown in the attached drawings, only for the convenience of describing the disclosure and simplifying the description, and does not indicate or imply that the device or element referred to must have a specific orientation, be constructed and operated in a specific orientation, so it cannot be understood as a limitation of the disclosure.

In addition, the terms “first” and “second” are only used for descriptive purposes, and cannot be understood as indicating or implying relative importance or implicitly indicating the number of indicated technical features. Therefore, the features defined as “first” and “second” may include one or more of these features explicitly or implicitly. In the description of the disclosure, unless otherwise specified, “multiple” means two or more. In the description of the disclosure, it should be noted that unless otherwise specified and limited, the terms “installation”, “connection” and “connecting” should be broadly understood, for example, they can be fixed connection, detachable connection or integrated connection. It can be a mechanical connection or an electrical connection; can be directly connected, can also be indirectly connected through an intermediate medium, and can be connected inside two elements. For those skilled in the art, the specific meanings of the above terms in the disclosure can be understood in specific situations.

### Embodiment 1

The embodiment of the disclosure provides a quench device for improving the mixing effect of quench gas and synthesis gas, which is used for guiding quench gas and improving the mixing effect of quench gas and synthesis gas.

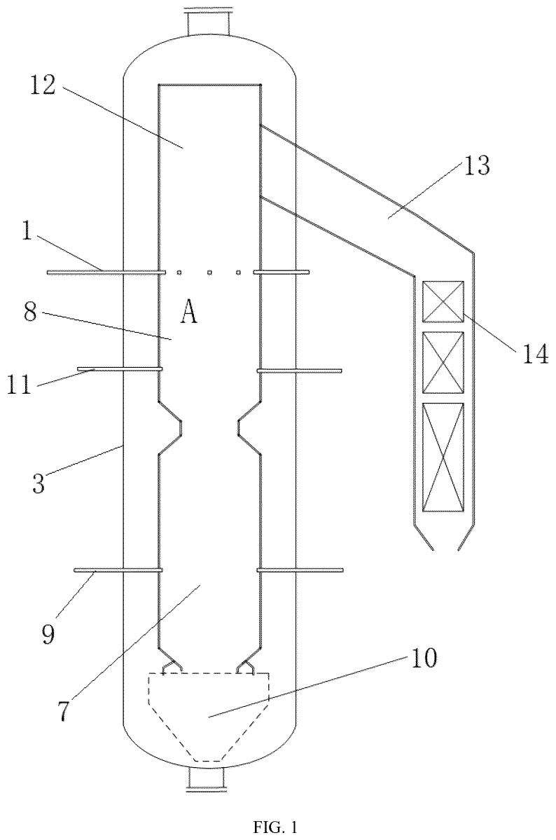

As shown in FIG. 1 to FIG. 5, a quench device for improving the mixing effect of quench gas and synthesis gas includes a plurality of quench gas ports 1 installed on a dry pulverized coal gasifier body 3 and guide wheels 2 installed in the quench gas ports 1. The cross section of the dry pulverized coal gasifier body 3 is a first imaginary circle 5, and a plurality of quench air ports 1 are arranged along the circumference of the first imaginary circle 5. The number of quench air ports 1 is positive even number, and every two quench air ports 1 form a rotary hedging group. Two quench air ports 1 of the same rotating counter group are arranged on the circumference of the same first imaginary circle 5 and symmetrically arranged around the center of the first imaginary circle 5. The guide wheel 2 is used to guide the quench air, so that the quench air itself rotates, and the flow rate of the guided quench air increases, where at least one rotary hedging group is provided with a guide wheel 2.

The quench device provided in the above embodiment is used for quenching the synthesis gas during the dry pulverized coal gasification. The device can guide the quench gas itself into a rotating state, increase the mixing intensity of the quench gas and the synthesis gas, mix the quench gas and the synthesis gas evenly, and enhance the heat exchange intensity of the quench gas and the synthesis gas. At the same time, the swirl flow generated by quench air can help ash and pulverized coal particles to adhere to the slag wall, help the gasifier slag layer to catch ash and unburned pulverized coal particles for gasification, increase the gasification efficiency and reduce the probability of blocking related channels, help the gasifier run safely and stably, improve the gasifier efficiency, reduce the blockage of downstream channels and reduce the risk of gasifier shutdown.

It should be noted that the center of the first imaginary circle 5 is on the vertical central axis of the dry pulverized coal gasifier body 3.

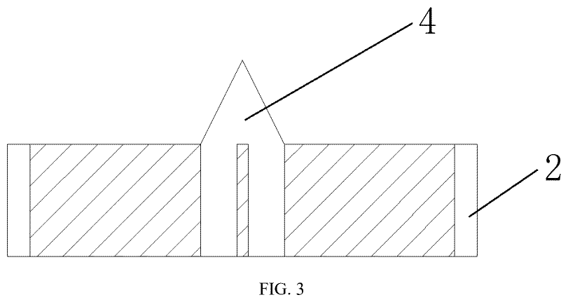

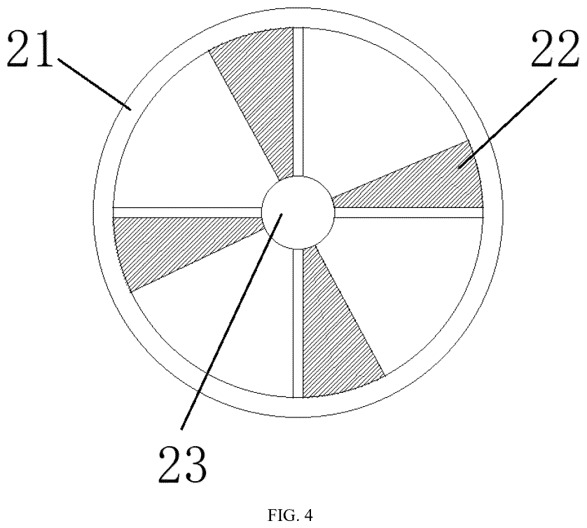

As shown in FIGS. 3 and 4, in an alternative embodiment, the guide wheel 2 includes a guide blade sleeve 21, guide blades 22 and a blade shaft 23. The guide blade sleeve 21 is used to connect with the quench air port 1. The guide blades 22 and the blade shaft 23 are arranged in the guide blade sleeve 21, and the guide blades 22 is fixedly connected with the blade shaft 23 and the guide blade sleeve 21.

In an alternative embodiment, the first end of the guide blade 22 is connected with the blade shaft 23, and the second end of the guide blade 22 is connected with the inner wall of the guide blade sleeve 21. The guide blade 22 is twisted from the first end to the second end. The number of guide blades 22 can be set to four, five, six and more, and the twisting directions and angles of these guide blades 22 are all the same.

As an example, the twisted shape of the guide blade 22 is similar to that of a turbine blade or the like, and is used for changing the flow direction of the quench air.

With the above scheme, since the guide blades 22 are twisted, the direction of the quench air passing through the guide blades 22 is also changed, and the quench air passing through the guide blades 22 rotates around the blade shaft 23.

As an example, the guide blades 22 can be connected with the blade shaft 23 and the guide blade sleeve 21 by welding.

In an alternative embodiment, one end, located at the air inlet side of the guide wheel 2 of the blade shaft 23 is provided with an inlet guide cone 4. Specifically, the shape of the inlet guide cone 4 is a conus, the tip of the conus faces the air intake direction, and the bottom of the conus is integrally connected with the blade shaft 23, the blade shaft 23 is coaxial with the inlet guide cone 4.

As an example, both the guide blade 22 and the blade shaft 23 are made of 8825 alloy material. The guide blade 22 can be twisted from an alloy plate with a thickness of 8 mm, or made by casting, 3D printing, numerical control machining, etc. This scheme is not specifically limited.

In an alternative embodiment, the quench air port 1 is arranged towards the center of the first imaginary circle 5; or, the extension line facing the quench air port 1 is tangent to the second imaginary circle 6, the second imaginary circle 6 is a concentric circle of the first imaginary circle 5, and the diameter of the second imaginary circle 6 is smaller than that of the first imaginary circle 5. In this embodiment, the quench gas is injected along the reverse direction of the synthesis gas, so that the fullness of the quench gas in the furnace is increased, and the mixing effect is further improved.

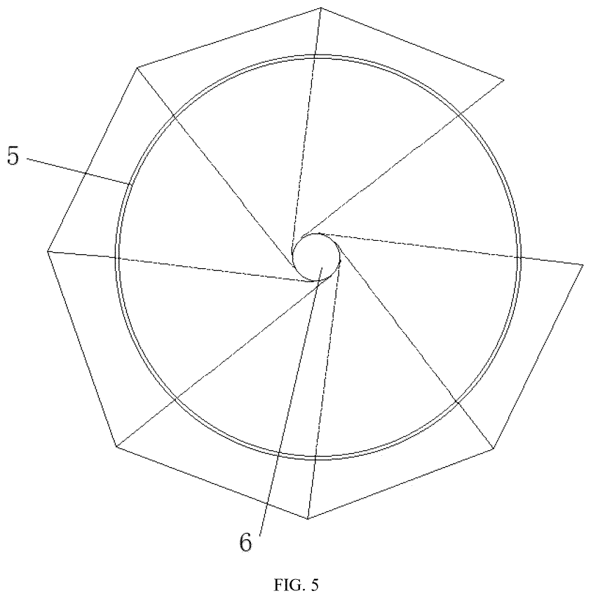

As shown in FIG. 5, eight quench gas ports 1 are arranged in FIG. 5, and the orientation of quench gas ports 1 in FIG. 5 is opposite to the rotation direction of synthesis gas.

In an alternative embodiment, the dry pulverized coal gasifier body 3 is provided with a cross section corresponding to a first imaginary circle 5, and at least one rotating hedging group is arranged on the circumference of the first imaginary circle 5.

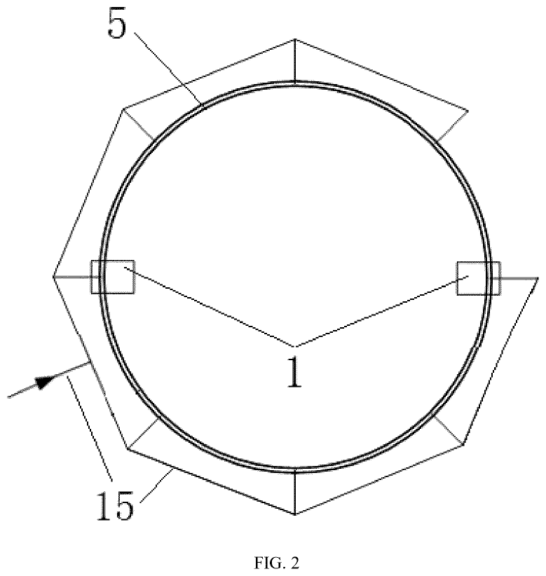

As shown in FIG. 2, as an example, the first imaginary circle 5 is provided with a rotating hedging group, that is, two quench air ports 1, and the air inlet pipeline 15 is connected to the quench air ports 1 for supplying quench air.

In an alternative embodiment, the dry pulverized coal gasifier body 3 is sequentially provided with at least two cross sections from top to bottom. Each of cross sections is provided with at least one rotary hedging group. Specifically, a plurality of layers of parallel first imaginary circles 5 can be arranged along the dry pulverized coal gasifier body 3 from top to bottom, and the quench air ports 1 can be arranged on the circumference of each layer of the first imaginary circles 5.

In an alternative embodiment, when at least two rotating hedging groups are arranged on the same cross section, the quench air ports 1 are uniformly arranged along the circumference of the first imaginary circle 5. Specifically, the circumference of the first imaginary circle 5 is divided into equal parts according to the number of quench air ports 1, and one quench air port 1 is arranged at each dividing point.

As an example, when there are two rotary hedging groups, there are four quench air ports 1 in total. When arranging, the circumference of the first imaginary circle 5 is divided into four equal parts, and one quench air port 1 is arranged at each equal part point. When there are three, four or more rotary hedging groups, the circumference of the first imaginary circle 5 is equally divided according to the number of quench air ports 1, and the quench air ports 1 are arranged according to the equally divided points.

As an example, when the guide wheel 2 is not installed, the quench air port 1 has a tubular shape, allowing quench air to be directly blown into the gasifier through the tubular port.

### Embodiment 2

A dry pulverized coal gasifier includes the quench device of Embodiment 1.

As shown in FIG. 1, the dry pulverized coal gasifier involved in this scheme can be a two-stage gasifier.

The dry pulverized coal gasifier includes a first-stage reaction chamber 7 and a second-stage reaction chamber 8, where the first-stage reaction chamber 7 is arranged below the second-stage reaction chamber 8 and the first-stage reaction chamber 7 is communicated with the second-stage reaction chamber 8. The low part of the first-stage reaction chamber 7 is provide with a first-stage pulverized coal burner 9, and the lower part is provided with a slag discharge port 10. The lower part of the second-stage reaction chamber 8 is provided with a second-stage pulverized coal burner 11, and the middle part is provided with a quench device.

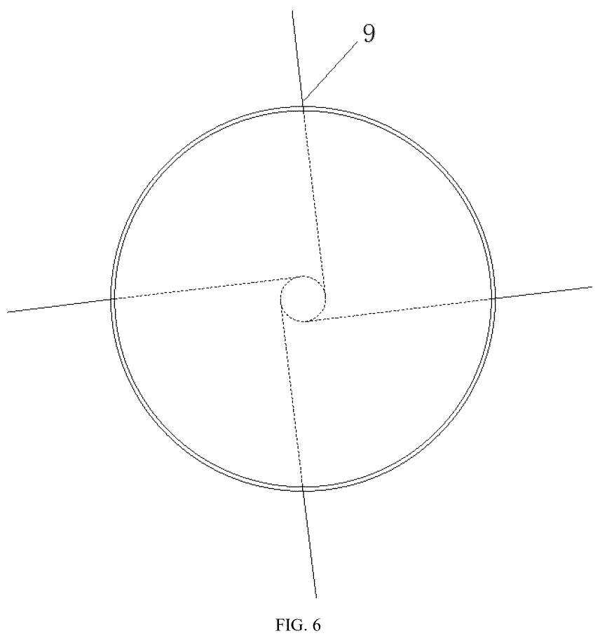

Specifically, as shown in FIG. 6, the first-stage pulverized coal burner 9 deflects at a certain angle when it is arranged, which is opposite to the deflection angle of quench air port 1. It should be noted that the term “opposite” in this scheme includes facing each other or having an included angle. For example, the orientation of the first-stage pulverized coal burner 9 may include a certain angle with the orientation of the quench gas port 1 when viewed from the top.

More specifically, the quench gas ports 1 are annularly arranged above the second-stage reaction chamber 8 of the two-stage gasifier, and the quench gas ports 1 are inserted into the dry pulverized coal gasifier body 3 along the circumferential direction of the two-stage gasifier. A synthesis gas outlet reverse chamber 12 is arranged above the quench device. The outlet of the synthesis gas outlet reverse chamber 12 is communicated with a heat exchanger channel 13, and a heat exchanger 14 is arranged in the heat exchanger channel 13, and the heat exchanger 14 is used for further cooling the second-stage synthesis gas output by the synthesis gas outlet reverse chamber 12.

Specifically, both the first-stage reaction chamber 7 and the second-stage reaction chamber 8 are surrounded by water cooling wall.

### Embodiment 3

A mixing method for quench gas and synthesis gas includes the following steps:

Coal and oxygen react in a first-stage reaction chamber 7 to obtain a first-stage synthesis gas. The first-stage synthesis gas enters the second-stage reaction chamber 8, and coal powder is further put into the second-stage reaction chamber 8 to react with the first-stage synthesis gas to obtain the second-stage synthesis gas.

The cooled synthesis gas is blown from the quench gas port 1 as quench gas, and the quench gas rotates with the inlet guide cone 4 as the axis under the action of the guide wheel 2 in the quench gas port 1. Specifically, the quench air in the quench air port 1 rotates with the blade shaft 23 (the blade shaft 23 is coaxial with the inlet guide cone 4) as rotation axis under the action of the guide blades 22, and the flow rate of the quench air increases. At the same time, because the extension line of facing the quench air port 1 is tangent to the second imaginary circle 6, at this time, the injecting direction of quench air rotating with the inlet guide cone 4 as the axis is opposite to the direction of the second-stage synthesis gas. After the quench air is injected from the quench air port 1, the quench air itself rotates and the quench air is opposite to the direction of the second-stage synthesis gas, and the quench air collides and mixes with the second-stage synthesis gas in the dry pulverized coal gasifier body 3, so that the quench air and the second-stage synthesis gas are fully mixed and exchange heat. At the same time, the rotating quench gas flow will increase the reaction time of ash particles and pulverized coal particles carried in the second-stage synthesis gas, so that they can be fully gasified, and will “throw” the ash particles and coal particles that are not fully reacted onto the water cooling wall, which is convenient for capturing the slag layer of the water cooling wall, reducing the ash content of the downstream synthesis gas and reducing the blocking risk of the downstream heat exchanger channel 13.

In the description of this description, descriptions referring to the terms “one embodiment”, “example” and “specific example” mean that specific features, structures, materials or characteristics described in connection with this embodiment or example are included in at least one embodiment or example of the disclosure. In this description, the schematic expressions of the above terms do not necessarily refer to the same embodiment or example. Moreover, the specific features, structures, materials or characteristics described may be combined in any one or more embodiments or examples in a suitable manner.

According to common technical knowledge, the disclosure can be realized by other embodiments without departing from its spirit or essential characteristics. Therefore, the embodiments disclosed above are only examples in all aspects, and are not unique. All changes that come within the scope of the disclosure or that are equivalent to the disclosure are embraced by the disclosure.

1. A quench device for improving mixing effect of quench gas and synthesis gas, comprising a plurality of quench gas ports installed on a dry pulverized coal gasifier body and a guide wheel installed in the quench gas ports;
wherein a cross section of the dry pulverized coal gasifier body is a first imaginary circle, and the plurality of quench air ports are arranged along a circumference of the first imaginary circle; a number of the quench air ports is positive even number, and every two quench air ports form a rotary hedging group; two quench air ports of a same rotating hedging group are arranged on a circumference of a same first imaginary circle and symmetrically arranged around a center of the first imaginary circle;
the guide wheel is used for guiding quench air; wherein at least one rotary hedging group is provided with the guide wheel;
the guide wheel comprises a guide blade sleeve, guide blades and a blade shaft;
the guide blade sleeve is used for being installed in the quench air ports and being connected with the quench air ports;
the guide blades and the blade shaft are arranged in the guide blade sleeve, and the guide blades is fixedly connected with the blade shaft and the guide blade sleeve;
the quench air ports are arranged towards the center of the first imaginary circle; or, an extension line facing each of the quench air ports is tangent to a second imaginary circle, the second imaginary circle is a concentric circle of the first imaginary circle, and a diameter of the second imaginary circle is smaller than a diameter of the first imaginary circle.

2. The quench device for improving mixing effect of quench gas and synthesis gas according to claim 1, wherein a first end of each of the guide blades is connected with the blade shaft, and a second end of each of the guide blades is connected with an inner wall of the guide blade sleeve.

3. The quench device for improving mixing effect of quench gas and synthesis gas according to claim 1, wherein an inlet guide cone is arranged at one end, located on an air inlet side of the guide wheel, of the blade shaft.

4. The quench device for improving mixing effect of quench gas and synthesis gas according to claim 1, wherein the dry pulverized coal gasifier body is provided with a cross section, and at least one rotating hedging group is arranged on a circumference of a first imaginary circle corresponding to the cross section.

5. The quench device for improving mixing effect of quench gas and synthesis gas according to claim 1, wherein the dry pulverized coal gasifier body is sequentially provided with at least two cross sections from top to bottom; at least one rotary hedging group is arranged on a circumference of a first imaginary circle corresponding to each of the cross sections.

6. The quench device for improving mixing effect of quench gas and synthesis gas according to claim 1, wherein when at least two rotating hedging groups are arranged on a circumference of a same first imaginary circle, the quench gas ports are uniformly arranged along a circumference of the first imaginary circle.

7. The quench device for improving mixing effect of quench gas and synthesis gas according to claim 1, wherein both the guide blades and the blade shaft are made of 8825 alloy material.

8. A mixing method for synthesis gas and quench gas, wherein the method is realized based on the quench device for improving mixing effect of quench gas and synthesis gas according to claim 1, the method comprises:
enabling quench air in the quench air ports to rotate with the blade shaft as a rotating shaft under an action of the guide blades, and enabling a flow rate of the quench air to increase, after the quench air is ejected from the quench air ports, performing collision and mixing with a second-stage synthesis gas in the dry pulverized coal gasifier body.
